(19) United States
(12) Patent Application Publication
(10) Pub. No.: US 2026/0153621 A1
(43) Pub. Date: Jun. 4, 2026

(54) POPULATION DENSITY PRESENTATION

(71) Applicant: Navico Group Americas LLC, Menomonee Falls, WI (US)

(72) Inventor: Jarred Clayton, Auckland (NZ)

(21) Appl. No.: 18/968,517

(22) Filed: Dec. 4, 2024

(51) Int. Cl. G01S 15/96; A01K 29/00; A01K 97/00; G01S 7/52; G06F 3/04847

(52) U.S. Cl. CPC G01S 15/96; A01K 29/005; A01K 97/00; G01S 7/52074; G06F 3/04847

(57) ABSTRACT

Systems and method for providing marine data are provided herein. The system comprises a display, a processor and a memory including computer program code configured to, when executed, cause the processor to cause presentation of a chart indicating at least a portion of a body of water. The computer program code is further configured to receive sonar data from one or more sonar transducers associated with a watercraft, the sonar data being associated with a corresponding location where it was captured. The computer program code is further configured to determine a population density of fish at a location based on the sonar data and generate a heat map based on the population density. The heat map indicates one or more population densities at corresponding locations on the chart. The computer program code is further configured to cause presentation of the heat map over the chart.

### FIELD OF THE INVENTION

Embodiments of the present invention generally relate to marine data, and more particularly, to presenting a visual indication of the location and concentration of biomass in an underwater environment determined at least partially from sonar data.

### BACKGROUND OF THE INVENTION

Sonar (SOund Navigation And Ranging) has long been used to detect waterborne or underwater objects. For example, sonar devices may be used to determine depth and bottom topography, detect fish, locate wreckage, etc. In this regard, due to the extreme limits to visibility underwater, sonar is typically the most accurate way to locate objects underwater. Sonar transducer elements, or simply transducers, convert electrical energy into sound or vibrations at a particular frequency. A sonar sound beam is emitted at a determined power output and transmitted into and through the water. The sound beam is reflected from objects it encounters (e.g., fish, structure, bottom surface of the water, etc.). The transducer(s) receives the reflected sound (the “sonar returns”) and convert the sound energy into electrical energy. Based on the known speed of sound, it is possible to determine the distance to and/or location of the waterborne or underwater objects.

The sonar return data, including any detected object therein may be converted into a visual sonar image which allows a user to view the underwater environment. Many fishers, both utilizing sonar images for sport and for recreational fishing, rely on the sonar images to identify where to cast in order to catch the fish represented in the sonar image. However, the sonar images capture the present environment of the underwater environment and are unable to show patterns or identify locations where fish populations historically have been.

Through ingenuity and hard work, the inventors have created a method of creating and presenting a heat map to identify population densities of objects, such as fish.

### BRIEF SUMMARY OF THE INVENTION

As noted above, sonar images show the current state of the underwater environment, but do not show or include historical population densities therein. Thus, although sonar data and corresponding sonar images may be taken over different time periods at the same or similar locations, the historical population density data are not included or otherwise readily available to the user. In this regard, the user is unable to look at the sonar image and determine whether the image is an accurate depiction of the current status or historical status of this location of the body of water. To explain, the sonar image depicts a snapshot of the underwater environment at the time of receipt of the sonar return data, however the sonar image generated from the sonar return data does not inform a user if the historical sonar data reflects similar activity or the robustness of the activity.

Embodiments of the present invention provide a system for presenting marine data, specifically for example, for presenting a heat map of the population density of underwater biomass, such as fish or other objects. The system analyzes sonar data to identify the number of fish, or other animals, therein at the location. The system may identify multiple variables to include within the population density including location, number of fish, time period, exact time, depth of the fish, size of the fish, environmental conditions (e.g., water temperature, wind speed, currents, etc.) or a species of a fish. Based on the variables, the system may determine a population density of the fish at a location, where the population density is the number of fish at a given location. The system may further generate a heat map of the population density, and overlay the heat map on a navigational chart such that a user can visually determine optimal fishing locations. The user may be able to further refine the heat map by selecting one or more variables to filter by to determine a population density and corresponding heat map in similar conditions.

In an example embodiment, a system for providing marine data is provided. The system comprises a display, a processor and a memory including computer program code. The computer program code is configured to, when executed, cause the processor to cause, on the display presentation of a chart indicating at least a portion of a body of water. The computer program code is further configured to receive sonar data from one or more sonar transducers associated with a watercraft, wherein the one or more sonar transducers are configured to emit one or more sonar beams into an underwater environment in a direction relative to the watercraft and to receive sonar returns corresponding to the one or more emitted sonar beams. The sonar data being associated with a corresponding location. The computer program code is further configured to determine based on the sonar data, a population density of fish at a location, and generate a heat map based on the population density. The heat map indicates one or more population densities at corresponding locations on the chart. The computer program code is further configured to cause, on the display, presentation of the heat map over the chart.

In some embodiments, the heat map may be generated based on at least one variable for the sonar data. The at least one variable may be a time period, a fish size a fish depth range, a current environmental condition, or a fish species. In some embodiments, the computer program code is further configured to when executed to cause the processor to receive an input indicating the at least one variable, and determine a filtered population density based on the indicated variable. The computer program code is further configured to generate an updated heat map based on the filtered population density and cause, on the display presentation of the updated heat map. In some embodiments, the time period may be a time of day, a time of year, or a specific time interval. In some embodiments, the computer program code may be further configured to, when executed, cause the processor to determine, automatically, a current time, and determine the population density based at least partially on the current time.

In some embodiments, the computer program code may be further configured to, when executed, cause the processor to determine a desired fish species and determine the population density based at least partially on the desired fish species.

In some embodiments, the computer program code may be further configured to, when executed, cause the processor the determine the population density based on external sourced sonar data corresponding to the location. In some embodiments, the external sourced sonar data identifies at least one variable, wherein the at least one variable is one of a time period, a fish size, a fish depth range, a current environmental condition or a fish species. In some embodiments, the heat map may comprise at least a first pattern corresponding to a first population density and a second pattern corresponding to a second population density. The first population density being different than the second population density.

In another example embodiment, a method for displaying marine information is provided. The method comprises receiving sonar data from one or more sonar transducers associated with a watercraft. The one or more sonar transducers are configured to emit one or more sonar beams into an underwater environment in a direction relative to the watercraft and to receive sonar returns corresponding to the one or more emitted sonar beams, wherein the sonar data is associated with a corresponding location. The method further comprises determining a population density of fish at a location based on the sonar data. The method further comprises generating a heat map based on the population density. The heat map indicating one or more population densities at corresponding locations on the chart. The method further comprises causing on the display presentation of the heat map over the chart.

In some embodiments, the heat map may be generated based on at least one variable of a time period, a fish size, a fish depth range, a current environmental condition or a fish species. In some embodiments, the method may further comprise receiving an input indicating the at least one variable, and determining the population density based on the indicated variable. In some embodiments, the time period may be a time of day, a time of year, or a specific time interval.

In some embodiments, the method may further comprise determining, automatically, a current time, and determining the population density based at least partially on the current time. In some embodiments, the method may further comprise determining a desired fish species, and determining the population density based at least partially on the determined fish species.

In some embodiments, the method may further comprise determining the population density based at least partially on external sourced sonar data. In some embodiments, the heat map may comprise at least a first pattern corresponding to a first population density and a second pattern corresponding to a second population density. The first population density and the second population density being different.

In yet another example embodiment, a marine electronics device is provided. The marine electronics device comprises a user interface comprising a display, a processor, and a memory including a computer program code. The computer program code, configured to, when executed, cause the processor to cause, on the display, presentation of a chart indicating at least a portion of a body of water and receive sonar data from one or more sonar transducers associated with a watercraft, wherein the one or more sonar transducers are configured to emit one or more sonar beams into an underwater environment in a direction relative to the watercraft and to receive sonar returns corresponding to the one or more emitted sonar beams. The sonar data being associated with a corresponding location. The computer program code is further configured to, when executed, cause the processor to receive at the user interface, an indication of a selected variable. The selected variable being one of a time period, a fish size, a fish depth range, a current environmental condition, or a fish species. The computer program code is further configured to, when executed, cause the processor to determine a population density of fish at a location based on the sonar data and the selected variable and generate a heat map based on the population density. The heat map indicating one or more population densities at corresponding locations on the chart. The computer program code is further configured to, when executed, cause the processor to cause, on the display, presentation of the heat map over the chart.

In some embodiments, the computer program code may be further configured to, when executed, cause the processor to determine the population density at least partially based on external sourced sonar data.

### BRIEF DESCRIPTION OF THE DRAWINGS

Having thus described the invention in general terms, reference will not be made to the accompanying drawings, which are not necessarily drawn to scale, and wherein:

FIG. 1 illustrates an example watercraft including various marine devices, in accordance with some embodiments discussed herein;

FIG. 2A illustrates a display of an example marine electronics device presenting a navigational chart, in accordance with some embodiments discussed herein;

FIG. 2B illustrates the display of an example marine electronics device presenting a split screen including the chart and a sonar image associated with the current location of the watercraft, in accordance with some embodiments discussed herein;

FIG. 3 illustrates a flowchart of an example method of machine learning, in accordance with some embodiments discussed herein;

FIG. 4 illustrates a display of an example marine electronics device presenting a heat map overlay on a navigational chart, in accordance with some embodiments discussed herein;

FIG. 5A illustrates a display of an example marine electronics device presenting a heat map overlay on a navigational chart, and illustrates example selectable variables for refining the heat map, in accordance with some embodiments discussed herein;

FIG. 5B illustrates the display of an example marine electronics device presenting an updated heat map overlay on the navigational chart accounting for a depth range, in accordance with some embodiments discussed herein;

FIG. 6A illustrates a display of an example marine electronics device presenting a heat map overlay on a navigational chart, in accordance with some embodiments discussed herein;

FIG. 6B illustrates the display of an example marine electronics device presenting an updated heat map overlay on the navigational chart for a selected time period, in accordance with some embodiments discussed herein;

FIG. 7A illustrates a display of an example marine electronics device presenting a heat map overlay on a navigational chart, in accordance with some embodiments discussed herein;

FIG. 7B illustrates the display of an example marine electronics device presenting an updated heat map overlay on the navigational chart, utilizing multiple data sources, in accordance with some embodiments discussed herein;

FIG. 8 illustrates a block diagram of an example system with various electronics devices, marine devices, and secondary devices shown, in accordance with some embodiments discussed herein; and

FIG. 9 illustrates a flow chart of an example method for presenting a heat map of biomass, in accordance with some embodiments discussed herein.

### DETAILED DESCRIPTION

Example embodiments of the present invention now will be described more fully hereinafter with reference to the accompanying drawings, in which some, but not all embodiments of the invention are shown. Indeed, the invention may be embodied in many different forms and should not be construed as limited to the example embodiments set forth herein; rather, these embodiments are provided so that this disclosure will satisfy applicable legal requirements. Like reference numerals refer to like elements throughout.

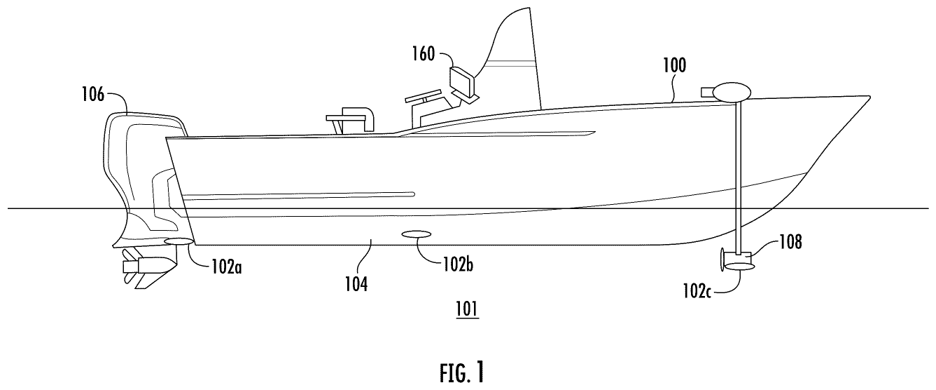

FIG. 1 illustrates an example watercraft 100 including various marine devices, in accordance with some embodiments discussed herein. As depicted in FIG. 1, the watercraft 100 is configured to traverse a marine environment, e.g., a body of water 101, and may use one or more sonar transducers 102a, 102b, 102c disposed on and/or proximate to the watercraft. Notably, example watercrafts contemplated herein may be surface watercrafts, submersible watercrafts, or any other implementation known to those skilled in the art. The sonar transducers 102a, 102b, 102c may each include one or more transducer elements configured to emit one or more sonar beams into an underwater environment of a body of water 101 in a direction relative to the watercraft 100. The sonar transducers 102a, 102b, 102c each receive sonar returns from one or more echoes of the one or more sonar beams emitted, and convert the sonar returns into sonar return data. Various types of sonar transducers may be utilized —for example, a linear downscan sonar transducer element, a conical downscan sonar transducer element, a sonar transducer array of elements, an assembly with multiple transducer arrays, or a sidescan sonar transducer element or array may be used.

Depending on the configuration, the watercraft 100 may include a primary motor 106, which may be a main propulsion motor such as an outboard or inboard motor. Additionally, the watercraft 100 may include a trolling motor 108 configured to propel the watercraft 100 or maintain a position. The one or more sonar transducers (e.g., 102a, 102b, 102c) may be mounted in various positions and to various portions of the watercraft 100 and/or equipment associated with the watercraft 100. For example, the sonar transducer may be mounted to the transom of the watercraft 100 such as depicted by sonar transducer 102a. In some embodiments, the sonar transducer may be mounted to the bottom or side of the hull 104 of the watercraft 100, such as depicted by sonar transducer 102b. In some embodiments, the sonar transducer may be mounted to the trolling motor 108 such as depicted by sonar transducer 102c.

The watercraft 100 may also include one or more marine electronic devices 160, such as may be utilized by a user to interact with, view, or otherwise control various functionality regarding the watercraft, including, for example, nautical charts and various sonar systems described herein. In the illustrated embodiment, the marine electronics device 160 may be positioned proximate the helm (e.g., steering wheel) of the watercraft 100—although other places on the watercraft 100 are contemplated. Likewise, additionally or alternatively, a remote device (such as a user's mobile device) may include functionality of a marine electronics device.

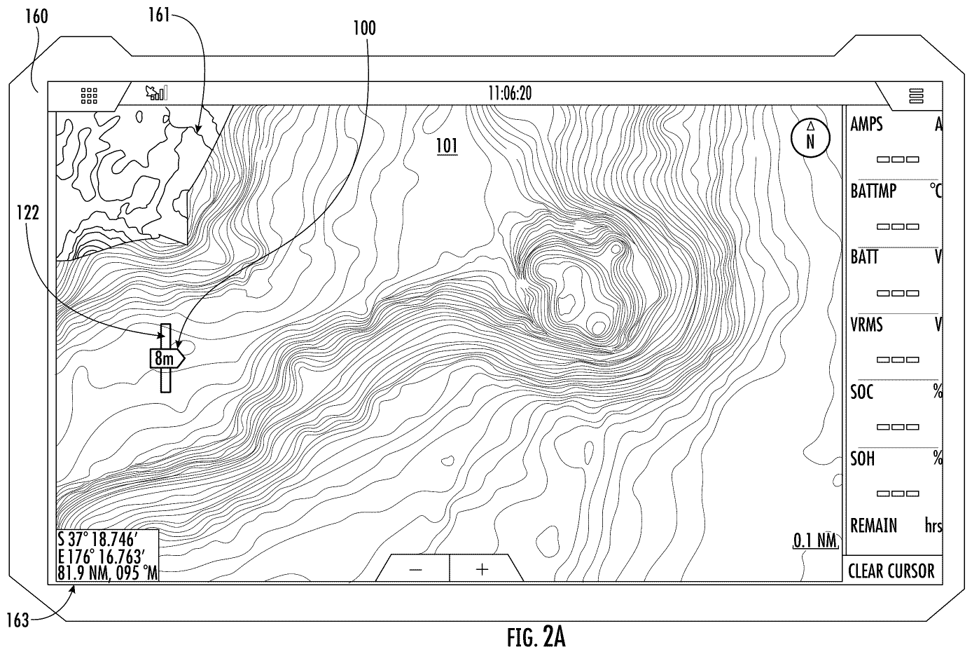

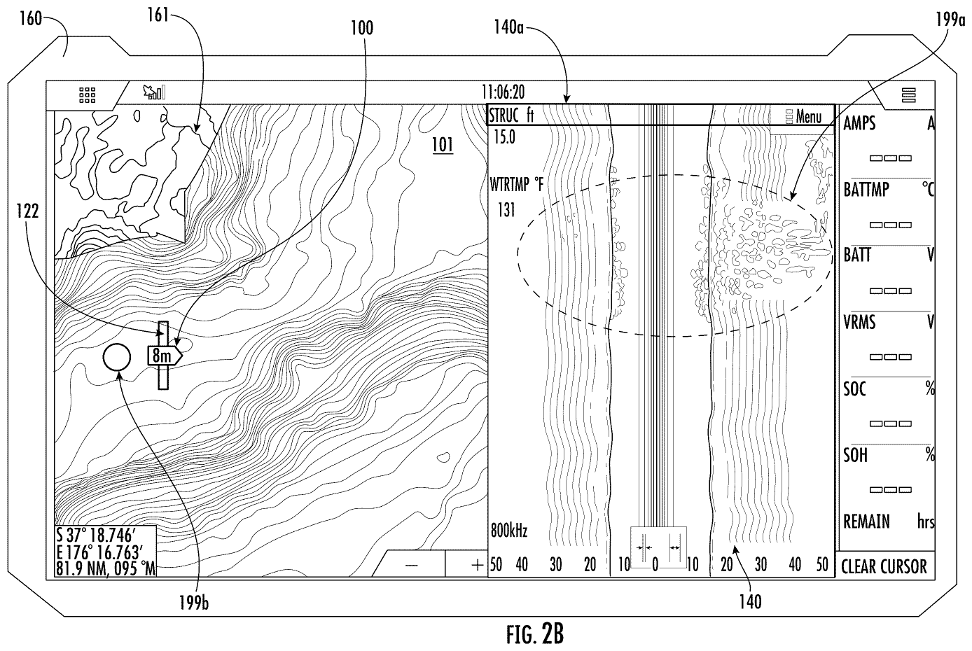

FIG. 2A depicts an example marine electronics device 160 presenting a navigational chart 161. The navigational chart 161 depicts an illustration of the watercraft 100 at a current location of the watercraft 100 in the body of water 101. In some embodiments, the navigational chart 161 may include other data 163 including the current location of the watercraft, the speed of the watercraft, the heading of the watercraft 100, and environmental conditions (e.g., air or water temperature, wind speed, etc.). The presentation of the navigational chart 161 may additionally include an indication of the sonar footprint 122. The sonar footprint 122 may indicate the coverage within the underwater environment of the one or more sonar transducers, and may indicate the type of sonar transducer currently active. For example, in the illustrated embodiment the sonar footprint 122 extends from the starboard side to the port side of the watercraft indicating a side scan sonar transducer in use. In other embodiments, the sonar footprint 122 may indicate a downscan, forwardscan, live scan, or other type of sonar transducer.

As discussed, the watercraft may be equipped with one or more types of sonar transducers and/or sonar transducer configurations, wherein each types and/or configurations thereof generate different sonar images views, which correspond to the type and/or configuration thereof.

FIG. 2B illustrates the marine electronics device 160 depicting a split screen presentation. On a first side of the marine electronics device 160 the navigational chart 161 is presented; and on a second side of the marine electronics device 160 a sonar image 140 is presented. In some embodiments, the overlay of the sonar footprint 122 presented on the navigational chart 161 may correspond to the view of the sonar image presented on the second side of the marine electronics device 160. The sonar image 140 may present a historical built-up sidescan sonar image, showing a current portion of the underwater environment at the current location—indicated as portion 140a. Additionally, prior captured sonar image portions are built up below the portion 140a. Notably, as the watercraft traverses the body of water, the sonar portions “drop off” the bottom in favor of putting up new portions that are collected. A user can scroll through the sonar data, but there is no easy way to discern which locations have good fish population densities. Thus, as discussed, although the sonar image illustrating the current underwater environment may be beneficial to aid in fishing once the user is in the location (e.g., indications of where to cast), the current sonar image 140 does not aid the user in determining the other locations, or past historical build up at various locations within the body of water.

In order to accurately identify fishing areas, sonar data, e.g., from local sources (e.g., one or more sonar transducers of the watercraft) and/or external sources (e.g., databases, servers, etc.) may be analyzed to determine an occurrence of a fish, the number of fish present within an area, and/or the species of fish. Additionally, other variables such as time of day, fish size, fish depth range, current environmental conditions, among other things can be determined and utilized from the sonar data.

FIG. 2B illustrates an example determination of a population density of fish in the sonar image 140. For example, it can be determined that sonar data associated with the location 199b on the chart produced a number of fish, such as illustrated at 199a. In some embodiments, the system may be configured to analyze the sonar image to determine population density of fish at a location—for example, in FIG. 2B, it can be determined that there are approximately 50 fish at location 199b. In some embodiments, this may be done by counting fish, while additionally or alternatively, this may be accomplished by estimating a size of the biomass and estimating the number of fish represented by the biomass. In some embodiments, the system may be configured to determine that the sonar image indicates the fish species (e.g., based on various factors, such as fish size, fish depth, time of year, location, etc.). In FIG. 2B, for example, the system may determine that the fish species is Walleye. Notably, other variables or factors can be determined using the sonar data (which is used to form the sonar image).

In some embodiments, artificial intelligence may be leveraged to analyze the sonar data and corresponding sonar images to determine these occurrences/variables, and compile the data to determine a population density and optionally create a heat map therefrom.

### Example Use of Artificial Intelligence

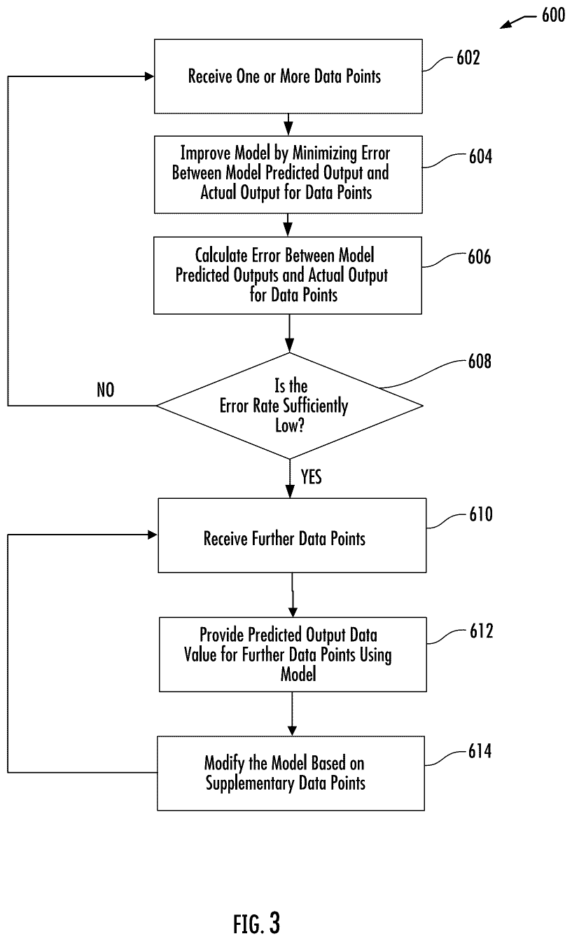

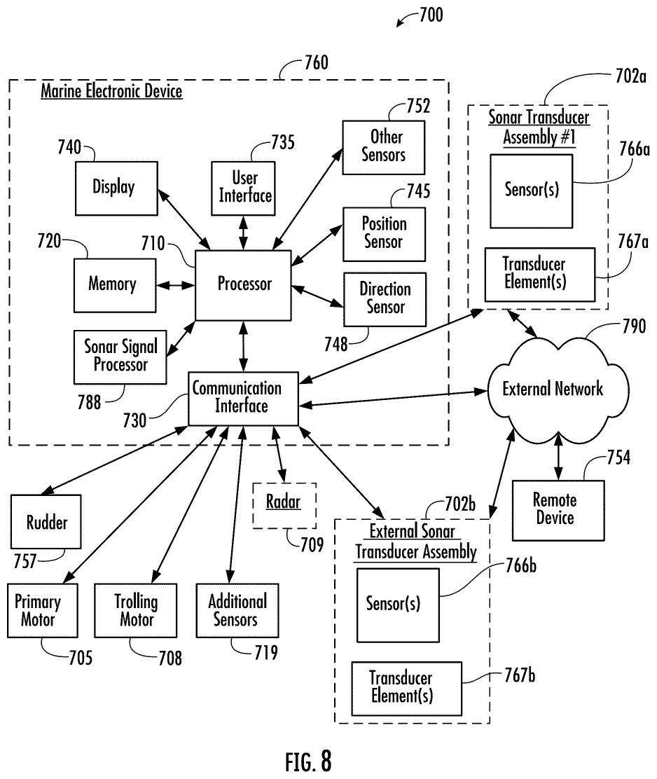

FIG. 3 is a flowchart of an example method 600 of machine learning, such as may be utilized with artificial intelligence for various embodiments of the present invention. At least one processor or another suitable device may be configured to develop a model for detecting biomass (e.g., fish, or other marine life), calculating a population density of the biomass, and/or identifying a species of the detected fish, such as described herein in various embodiments. In this regard, the developed model may be deployed and utilized to determine an occurrence of a biomass, determine a population density, an/or determine biomass characteristics (e.g., species) for the one or more biomass objects that are detected within sonar data. In some embodiments, marine electronics device (e.g., 760 FIG. 8) or corresponding remote device (e.g., 754 FIG. 8) may comprise one or more processors that perform the functions shown in FIG. 3.

This system may beneficially determine the occurrence of a biomass (e.g., a fish), a number of occurrences, and a type of biomass (e.g., species of fish) by accounting for sonar data and different types of additional data, and the developed model may assign different weights to different types of data that are provided. In some systems, even after the model is deployed, the systems may beneficially improve the developed model by analyzing further data points. By utilizing artificial intelligence, a novice user may benefit from the experience of the models utilized, making systems more user friendly and accessible/successful for beginners. Embodiments beneficially allow for accurate information to be provided about the objects represented within sonar data and also allow for information about these objects to be shared with the user (such as on the display) of the remote electronic device so that the user may make well-informed decisions. Additionally, the techniques may also enable displays that allow novice users to quickly and easily decipher sonar data and design search patterns and or suggested routes between detected objects. Utilization of the model may prevent the need for a user to spend a significant amount of time reviewing sonar data and other information, freeing the user to perform other tasks and enabling performance and consideration of complex estimations and computations that the user could not otherwise solve on their own (e.g., the systems described herein may also be beneficial for even the most experienced users).

By receiving several different types of data, the example method 600 may be performed to generate complex models. The example method 600 may find relationships between different types of data that may not have been anticipated. By detecting relationships between different types of data, the method 600 may generate accurate models even where a limited amount of data is available.

In some embodiments, the model may be continuously improved even after the model has been deployed. Thus, the model may be continuously refined based on changes in the systems or in the environment over time, which provides a benefit as compared with other models that stay the same after being deployed.

At operation 602, one or more data points are received. These data points may or may not be the initial data points being received. These data points preferably comprise known data regarding detection of a biomass, a biomass-type, biomass depth, biomass velocity, or some other biomass characteristic that the model may use to determine the occurrence of a biomass, and further to calculate a biomass score to indicate the likelihood that the biomass detected is a known biomass type. For example, where the model is being generated to provide an indication of the occurrence of a biomass, the data points provided at operation 602 preferably comprise known data that corresponds to identifying the occurrence of a biomass. Similarly, when the model is being generated to provide an indication of the type of biomass, the data points provided at operation 602 preferably comprise known data that corresponds to identifying the biomass-type of the detected biomass. The data points provided at operation 602 will preferably be historical data points with verified values to ensure that the model generated will be accurate. The data points may take the form of discrete data points. However, where the data points are not known at a high confidence level, a calculated data value may be provided, and, in some cases, a standard deviation or uncertainty value may also be provided to assist in determining the weight to be provided to the data value in generating a model. In this regard, the model predicted biomass characteristic and/or predicted biomass-type may be formed based on historical comparisons of the sonar data and additional data.

For example, the model may be formed based on historical comparisons of a historical biomass detection, and/or biomass-type with historical sonar data and historical additional data, and a processor may be configured to utilize the developed model to determine an biomass score indicating the likelihood of a detected biomass, and a biomass type score, indicating the likelihood of the detected biomass being a known biomass type. In some embodiments, the model may further be able to detect the occurrence of a biomass and determine an estimated biomass-type for a biomass represented in sonar data. This model may be developed through machine learning utilizing artificial intelligence based on the historical comparisons of the historical biomass-type with historical sonar data and historical additional data. Alternatively, a model may be developed through artificial intelligence, and the model may be formed based on historical comparisons of additional data and the sonar data. A processor may be configured to use the model and input the sonar data and the additional data into the model to determine the one or more biomass characteristics.

Another example of appropriate historical comparisons may include comparing additional data (e.g., geographical data from maps or nautical charts, temperature data, time data, etc.) with sonar return data. Additional data may be provided from a variety of sources, and additional data may, for example, be provided from a camera, a radar, a thermometer, a clock, a pressure sensor, a direction sensor, or a position sensor.

At operation 604, a model is improved by minimizing error between a calculated biomass score and/or an estimated biomass type score generated by the model and an actual biomass type for data points. In some embodiments, an initial model may be provided or selected by a user. The user may provide a hypothesis for an initial model, and the method 600 may improve the initial model. However, in other embodiments, the user may not provide an initial model, and the method 600 may develop the initial model at operation 604, such as during the first iteration of the method 600. The process of minimizing error may be similar to a linear regression analysis on a larger scale where three or more different variables are being analyzed, and various weights may be provided for the variables to develop a model with the highest accuracy possible. Where a certain variable has a high correlation with one or more biomass types and object characteristics, that variable may be given increased weight in the model. For example, where data from maps or nautical charts are available, that data may be provided alongside with sonar data, and the model may be optimized to give the map data its appropriate weight. In refining the model by minimizing the error between the predicted occurrence of a biomass, and the predicted biomass types generated by the model and the actual or known biomass type, the component performing the method 600 may perform a very large number of complex computations. Sufficient refinement results in an accurate model.

In some embodiments, the accuracy of the model may be checked. For example, at operation 606, the accuracy of the model is determined. This may be done by calculating the error between the model predicted biomass occurrence, and/or biomass-type generated by the model and the actual biomass occurrence and/or actual biomass type from the data points. In some embodiments, error may also be calculated before operation 604. By calculating the accuracy or the error, the method 600 may determine if the model needs to be refined further or if the model is ready to be deployed. Where the object type is a qualitative value or a categorical value such as a vehicle, person or animal, the accuracy may be assessed based on the number of times the predicted value was correct. Where the biomass type is a quantitative value (e.g., an biomass score, an biomass type score), the accuracy may be assessed based on the difference between the actual value and the predicted value.

At operation 608, a determination is made as to whether the calculated error is sufficiently low. A specific threshold value may be provided in some embodiments. For example, where the biomass characteristic is length, the threshold may be 0.1 meters, and the calculated error may be sufficiently low if the average error is less than or equal to 0.1 meters. However, other threshold values may be used, and the threshold value may be altered by the user in some embodiments. If the error rate is not sufficiently low, then the method 600 may proceed back to operation 602 so that one or more additional data points may be received. If the error rate is sufficiently low, then the method 600 proceeds to operation 610. Once the error rate is sufficiently low, the training phase for developing the model may be completed, and the implementation phase may begin where the model may be used to predict the expected biomass type.

By completing operations 602, 604, 606, and 608, a model may be refined through machine learning utilizing artificial intelligence based on the historical comparisons of additional data and sonar data and based on known deviations of the sonar data for the historical comparisons. Notably, example model generation and/or refinement may be accomplished even if the order of these operations is changed, if some operations are removed, or if other operations are added.

During the implementation phase, the model may be utilized to provide a determined biomass type. An example implementation of a model is illustrated from operations 610-612. In some embodiments, the model may be modified (e.g., further refined) based on the received data points, such as at operation 614.

At operation 610, further data points are received. For these further data points, the biomass occurrence, biomass characteristic and/or biomass-type may not be known. At operation 612, the model may be used to provide a predicted output data value for the further data points. Thus, the model may be utilized to determine the occurrence of a biomass, and/or the biomass type.

At operation 614, the model may be modified based on supplementary data points, such as those received during operation 610 and/or other data points. For example, the model may be refined utilizing the sonar data, additional data, and the determined biomass characteristics and/or biomass-types, such as described herein. By providing supplementary data points, the model can continuously be improved even after the model has been deployed. The supplementary data points may be the further data points received at operation 610, or the supplementary data points may be provided to the processor from some other source. In some embodiments, the processor(s) or other component performing the method 600 may receive additional data from secondary devices and verify the further data points received at operation 610 using this additional data. By doing this, the method 600 may prevent errors in the further data points from negatively impacting the accuracy of the model.

In some embodiments, supplementary data points are provided to the processor from some other source and are utilized to improve the model. For example, supplementary data points may be saved to a memory e.g., (720 of FIG. 8) associated with at least one processor (e.g., 710 FIG. 8) via communication interface 730, or the supplementary data points may be sent through the external network 790 from a remote electronic device 754. These supplementary data points may be verified before being provided to the at least one processor 710 to improve the model, or the at least one processor 710 may verify the supplementary data points utilizing additional data.

As indicated above, in some embodiments, operation 614 is not performed and the method proceeds from operation 612 back to operation 610. In other embodiments, operation 614 occurs before operation 612 or simultaneous with operation 612. Upon completion, the method 600 may return to operation 610 and proceed on to the subsequent operations. Supplementary data points may be the further data points received at operation 610 or some other data points.

### Example Determinations and Data Usage

As indicated herein, in some embodiments, the system may be configured to identify the occurrence of a biomass (e.g., fish), determine a number of occurrences of the biomass, and/or identify a biomass species within the sonar return data. The system may utilize biomass characteristics, environmental characteristics, and/or previous inputs, such as inputs for the artificial intelligence techniques described above, and/or the system may use biomass characteristics, environmental characteristics and/or previous inputs to determine the occurrence of a biomass, the number of occurrences, and/or the type of biomass through other approaches, such as through an algorithmic approach.

In some embodiments, the system may be utilized to determine the occurrence of a biomass within sonar return data, determine the number of occurrences of biomass, and determine the species of the biomass at each indicated occurrence. The system may utilize the corresponding data to determine a population density of the detected biomass (e.g., fish) and generate a heat map overlay to visually indicate historical locations of biomass, and suggest or otherwise indicate ideal fishing areas.

In some embodiments, the system may be configured to determine that a biomass, for example a fish, or other object is present within the sonar data. In this regard, the sonar data may include various sonar signal returns that comprise an amplitude, a time of flight (e.g., time of reflection of the signal), a receipt time (e.g., when the sonar signal was received), and an angular direction (e.g., relative to the direction of the sonar, watercraft, and/or waterline). Individual sonar signal returns may be captured in memory and used to identify objects within the sonar data. In some embodiments, a cluster of similar sonar signal returns may be used to determine occurrence of an object (e.g., via the amplitude and angular direction/time of flight). In some embodiments, relative movement of a grouping of sonar signal returns across different receipt times may be used to determine an object within the sonar data. In some embodiments, additional data (e.g., automatic identification system (AIS) data, weather data, other sonar data, historical data, chart data, etc.) may be used to determine that a group of sonar signal returns correspond to an object within the sonar data.

Once the biomass is detected, the system may utilize additional data, including biomass characteristic (e.g., shape, depth, velocity of the biomass, etc.) and/or environmental data (e.g., water temperature, air temperature, wind, currents, season, time of day, etc.) to estimate the species of the detected biomass. For example, data points may comprise sonar data and/or other additional data (including historical data, and charts); and the data points may be provided to develop a model that may assign a likely species and a confidence attached to the species identification. For example, sonar data may be provided alongside other additional data such as weather data, data from maps and nautical charts, and AIS data. Then the data sets may be used to determine biomass characteristics that may be used to determine the biomass score.

In some instances, determining the occurrence of a biomass may be difficult as two or more biomasses may be located at the same position or within the same area. For example, two biomasses may be represented at the same location when both are in close proximity (e.g., depth and relative distance from the sonar transducer assembly). This may cause the sonar data presented in the display at that location to have a high intensity relative to other locations within the display. Through the use of data from different types of sonar images, data from sonar images presented over time, and additional data, the outline of the biomasses may be determined so that two different biomasses may be readily distinguished. Additional data may be used alongside the available sonar data to develop and improve a model that may predict the occurrence of a biomass, occurrence of multiple biomasses, and/or the species of the biomass and distinguish between two adjacent biomasses. As a greater amount of data points are provided to the model, the accuracy of the model may be further improved.

In some embodiments, known historical data may be provided to help improve the model. For example, known historical data may be provided for an indication of an occurrence of a biomass, and the occurrence may be confirmed by the user. By providing sufficient data to the model, the model may be improved over time.

In some embodiments, the outline of the biomass may be detected by recognizing time-based patterns in the movement of the objects. This may be done through the use of Long Short-Term Memory (“LSTM”) networks to recognize patterns in sequences of data. Where two biomasses are overlapping within sonar data, LSTM networks may be used to identify the movement of one biomass with respect to the other object. For example, when the detected biomass is a fish, and the fish is swimming above certain structure that is represented in sonar data in a downscan image, LSTM networks may recognize a change in the intensity of the sonar data over time and associate this changing intensity with the movement of the fish. Additionally, if enough data is retained, the outline of the fish may be known from previous sonar images where the fish and the structure do not overlap. Although here the biomass is described as a fish, other types of detected objects are also considered.

Other biomass characteristics may also be determined for various biomasses represented within a display. For example, the velocity or the direction that the biomass is heading may be determined based on (1) a comparison of previously determined locations and the most recently obtained location of the biomass to determine a biomass path of the biomass, wherein the locations are obtained from a source such as AIS or sonar; and/or (2) the speed of a water current at the watercraft of the user or the water current speed at the biomass location. Other data may also be used to determine the velocity and movement direction of the biomass, such as the region, the time of day and time of year, water pressure, etc.

Additional data may be provided in various forms to assist with determining different biomass characteristics. Additional data may include temperature data, pressure data, precipitation data, water current data, weather data, radar data, GPS data, compass data, heading sensor data, position data for a watercraft, directional data for one or more unmanned devices, directional data from a propulsion system of an unmanned device, image data from a camera, data regarding the date or time, navigational data, or geographical data. However, other types of data may also be provided. Using the additional data and various data types that are available, an accurate model may be developed. Some data types may have a negligible correlation to a specific object characteristic and may not be considered in the model. However, where a large number of data types are available, the system may beneficially find an unexpected correlation between one data type and a desired object characteristic. Thus, a large number of different data types may preferably be used.

In some embodiments, any number of biomass characteristics may be used, and correlation patterns of biomass characteristics can be utilized to determine a detected biomass score with reference to a desired biomass. In this regard, various patterns of biomass characteristics may lead to determination of estimated biomass-types. Some example biomass characteristics that may be determined and then utilized to determine an estimated biomass-type include at least one of a shape of the biomass, a depth of the biomass, an environment of the biomass, a velocity of the biomass, a temperature of the water, an intensity of the sonar data, an intensity of the additional data, a behavior of the biomass, a geographical area, a time of day, or a time of year. In this regard, the correlated patterns of biomass characteristics may lead to a determination of an estimated biomass-type (e.g., a type of fish) that can then be provided to the user for easy identification of biomasses.

### Example Displays and Features

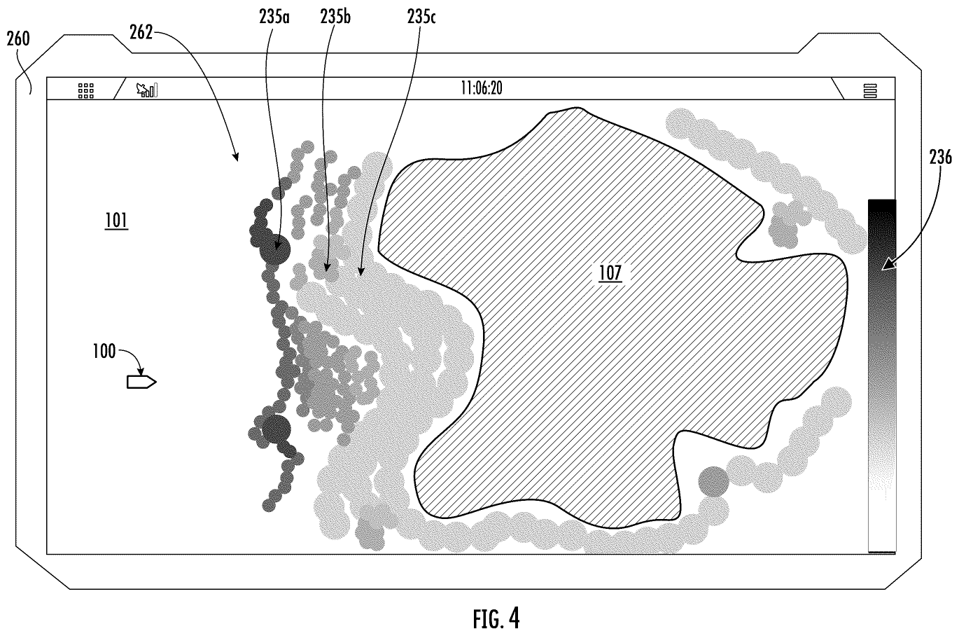

FIGS. 4-7B illustrate a marine electronics device presenting various navigational charts, and heat map overlays presented thereon. The marine electronics device may be in data communication with the sonar transducers such that the marine electronics device may receive sonar data from the one or more sonar transducers. The marine electronics device may be configured to present a navigational chart and an overlay of population density of a biomass depicted as a heat map. The heat map may provide a visual indication to the user of the average population of the desired biomass across the body of water, thereby indicating to the user desirable areas to fish. The population density, and therefore, in some embodiments, the heat map, may be customizable via at least one variable to further refine the population density and identify the best areas which align with the user's desires.

FIG. 4 illustrates an example marine electronics device 260 presenting a heat map 262 overlaid on a navigational chart (e.g., 161 FIG. 2). As discussed, the heat map 262 provides a visual indication of a population density in the area. The population density may be determined through analyzing sonar data which includes data indicating at least a number of fish detected, and a corresponding location of the detected fish. Utilizing the sonar data, the population density may be calculated based at least partially on the number of fish detected and the location of the detection, as the population density is an indication of the number of fish within an area.

The heat map 262 comprises one or more indications of the population density within the underwater environment 101. In this regard, the heat map 262 may include at least a first indication 235a of a first population density, a second indication 235b of a second population density, and a third indication 235c of a third population density. In some embodiments, each population density indication may be a unique pattern such as to differentiate between population densities. In some embodiments, the pattern may be a color, a shade, a pattern, a shape, or other readily identifiable feature, such that the user may visually distinguish between population density indications. In some embodiments, the population density overlay 262 may comprise a legend 236 to identify the value corresponding thereto. In some embodiments, the indication may directly correspond to a number, while in other embodiments the indication may correspond to a qualitative value. In some embodiments, the population density may be represented by a color gradient extending between two colors, for example, black and white. In such representation, the end of the spectrum may indicate a high population density, while the other end of the spectrum may indicate a low population density, and the gradient therebetween may indicate how close the population density is to one of the ends of the spectrum. Notably, by providing such a heat map, a user can quickly discern locations that have a high population density and, thus, be able to quickly find fishing spots that may likely lead to more fish catches.

As discussed herein, it may be desirable to filter the population density results to include data collected during comparable conditions (e.g., similar environmental conditions, time period), which reflect the current conditions, and/or that are targeted for the user's desires. Other times, the user may want to catch a certain species of fish, for example one which lives within a predictable depth range, or an in-season fish. In this regard, it may be desirable to show a heat map where the population density displayed is filtered for the specific conditions, and/or other variables the user wants.

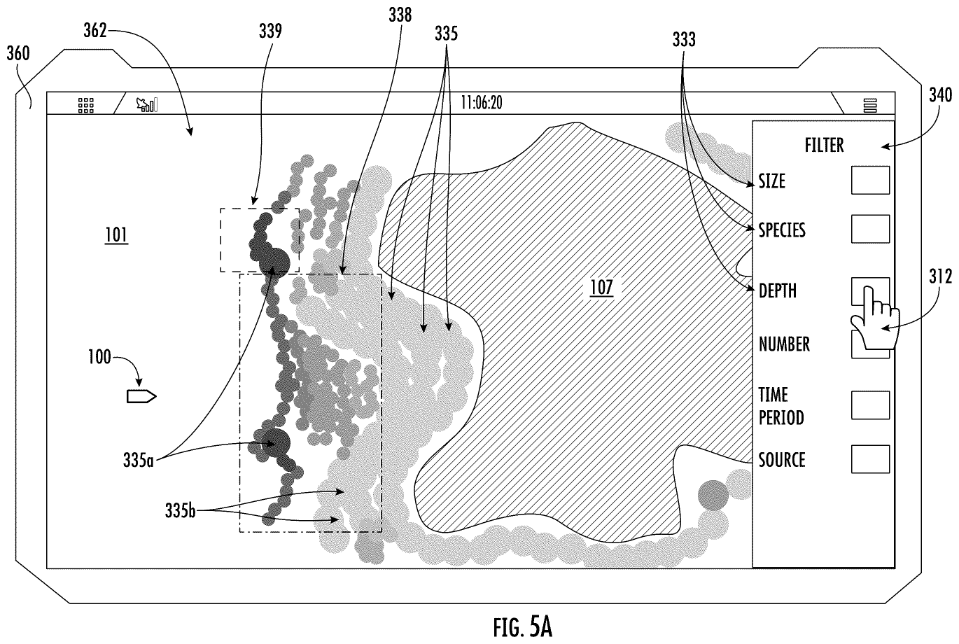

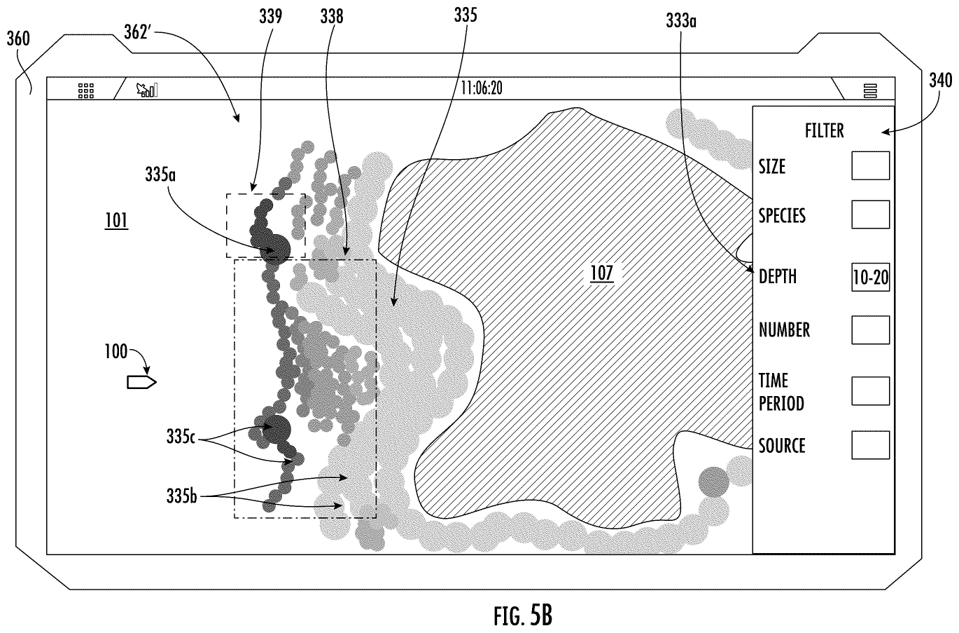

FIGS. 5A-B illustrate an example marine electronics device 360 presenting a heat map 362 overlay on a navigational chart (see e.g., 161 FIG. 2). FIG. 5A illustrates the initial presentation of the heat map 362, and FIG. 5B illustrates an updated heat map 362′ for the same geographic area. In some embodiments, the initial heat map 362 presentation may be based on default settings, or the user's last settings. As discussed, the heat map 362 presents an indication 335 of the population density according to the selected variables. To further refine or recalculate the population density to align with the current conditions, the marine electronics device 360 may include a filter 340 which defines at least one variable 333 which may be selected. In some embodiments, the at least one variable 333 may be one of a fish size (e.g., weight or length), a fish species, a depth range, a fish number, a time period, current environmental conditions, and a source of the data.

In order to choose and change the at least one variable 333 a user 322 user may select the at least one variable 333 from the filter 340. To illustrate the effects of applying one or more variables as a filter, a first area 338 and a second area 339 are highlighted in the initial heat map 362. The first area 338 includes both areas of high population density and areas of low population density, whereas the second area 339 includes an area of high population density. In this regard, as discussed, the heat map comprises indications 335 which correlate to the population density. In the illustrated embodiment, a first indication 335a may be a dark coloration, indicating a high population density, while a second indication 335b may be a light coloration indicating a low population density, with the other indications being a color in a gradient between the dark coloration and the light coloration to indicate a population density therebetween.

In the illustrated embodiment, a depth range 333a is the selected variable 333. Upon selection of the variable, and further defining a range of the variable, a filtered population density may be calculated, and the updated heat map 362′ may be generated and presented on the marine electronics device. The updated heat map 362′, as shown in FIG. 5B depicts the filtered population density of fish detected at a depth range between 10-20 feet.

To determine the filtered population density and form the corresponding updated heat map 362, the marine electronics device 360 may review sonar data stored in the memory of the marine electronics device, or in a remote memory, for sonar data that was previously collected. The marine electronics device 360 may analyze the sonar data to determine a historical population density which corresponds to the selected at least one variable, and generate a corresponding updated heat map 362′. In some embodiments, the updated population density may be an average population density, such that the population density shows an average population density in that area. While in other embodiments the population density may show all historical fish detected.

In this regard, between the initial heat map 362 and the updated heat map 362′, the user may be able to visually see the change in the population densities in the first area 338 and the second area 339. In the updated heat map 362′ the population density within the first area 338 is represented by the second indication 335b, and a third indication 335c, which shows a general decrease in the population density. In some embodiments, the third indication 335c is a color between the first indication 335a and the second indication 335b thereby indicating the third population density is less than the first population density and greater than the second population density. Thus, the user is able to visually see the population density within the first area 338 decreases when the at least one variable is depth 333a between 10-20 feet. Further, the user may infer that the fish detected, and shown in the initial heat map 362, were either detected at a depth of less than 10 feet, or greater than 20 feet.

In some embodiments, the depth range may be a preset value of a range of at least 5 feet, at least 10 feet, or at least 20 feet. In some embodiments, the depth range may correspond to the depth of the body of water, for example a deeper body of water may have larger preset depth ranges, than a more shallow body of water.

In contrast, in both the initial heat map 362 and the updated heat map 362′ the population density of the second area 339 is depicted with the first indication 335a. In this regard, the fish that were detected without the depth 333a filter, were likely all within the depth range 333a of 10-20 feet.

Thus, for certain variables, the marine electronics device may analyze all of the sonar data which corresponds to the body of water to determine filtered population densities. In another example, a user may want to filter by fish species. In such embodiments, the user may select one or more desired fish species, and the marine electronics device may analyze the historical sonar data corresponding to the body of water. The marine electronics device, such as by utilizing various algorithms and/or artificial intelligence as discussed, may identify the selected species from the sonar data, and generate a filtered population density, and updated heat map, to correspond to the desired fish species.

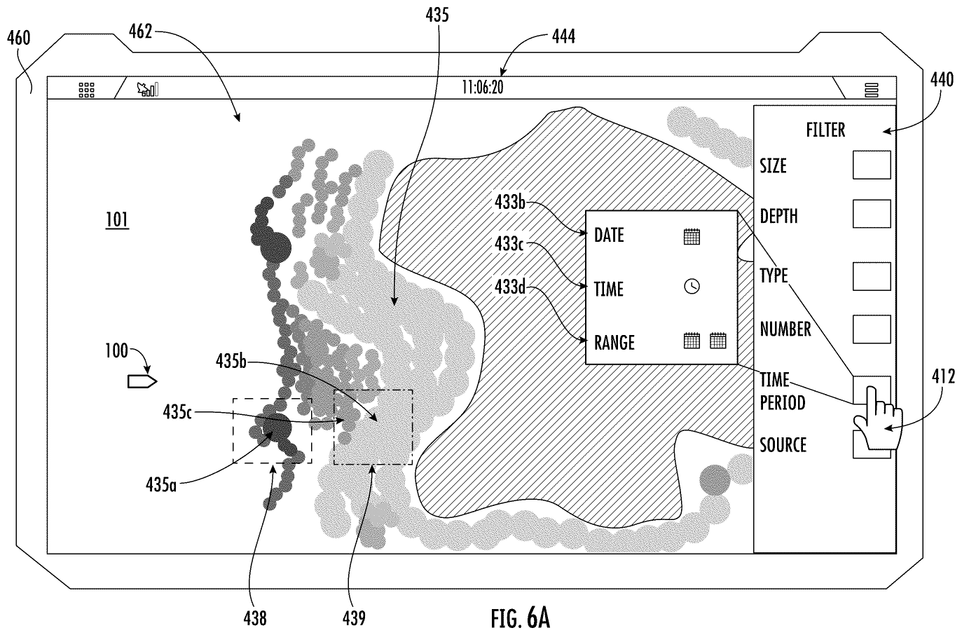

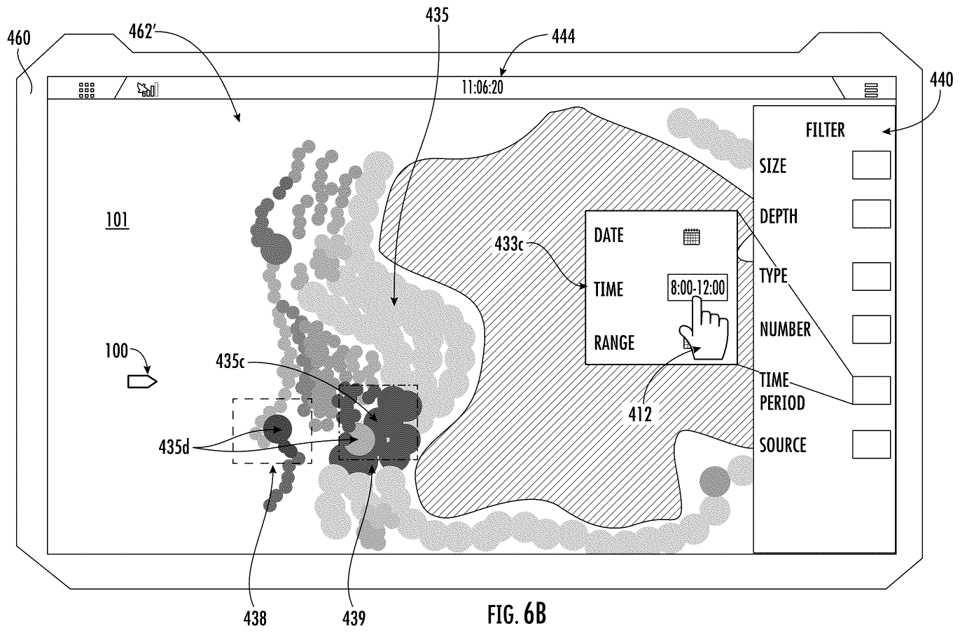

In another example embodiment, the user may want to filter the results based on time period, as the water temperature changes throughout the season, or even over the course of the day, and as a result fish may migrate to warmer water (or other different scenarios may occur). FIGS. 6A-B illustrate using time periods to filter the population density. FIG. 6A illustrates an initial heat map 462 presented on a marine electronics device 460. The initial heat map 462 is overlaid on a navigational map (e.g., 161 FIG. 2) which includes indications 435 which correspond to the population density within that area. In the illustrated embodiment a first indication 435a corresponds to a first population density, a second indication 435b corresponds to a second population density, and a third indication 435c corresponds to a third population density, each of the population densities being different. In the illustrated embodiment, the initial heat map 362 highlights a first area 438, which includes mostly the first indication 435a indicating a high population density, and a second area 439, which includes both the second indication 435b indicating a low population density, and the third indication 435c indicating a population density between the first population density and the second population density.

To filter the population density by time period, a time period may be selected by a user 412 from the filter 440. In some embodiments, the time period may be a specific date 433b, a time range 433c, and/or a date range 433d. In other embodiments the time period may be a time of day, a time of year, or a specific time interval. In this regard, the use 412 may select one or more of these variables to create a filtered population density and corresponding heat map. In some embodiments, the marine electronics device 460 may also indicate the current time 444 of use of the marine electronics device. In the illustrated embodiment, the user 412 selects a time range 433c between 8:00 am and 12:00 pm.

In other embodiments, the marine electronics device may automatically filter the population density based on the current time. In this regard, the system may determine the current time 444, and the marine electronics device may automatically determine a time range which includes the current time 444. In some embodiments, the time range 433c may be a period of at least an hour, at least two hours, at least three hours, or even at least four hours. Further, the system may determine an updated time, and review sonar data corresponding to the updated time to create an updated population density and corresponding heat map based on the updated time.

Thus, the user, may manually select the time period (e.g., time range, and/or duration) or the user may have the marine electronics device automatically select and update the time frame in response to the current time of use.

To determine the filtered population density and form the corresponding updated heat map 462, the marine electronics device 460 may review sonar data stored in the memory of the marine electronics device, or in a remote memory, for sonar data that was collected during the specified time period. The marine electronics device 460 may analyze the sonar data to determine a historical population density within that time frame and generate a corresponding updated heat map 462′.

FIG. 6B illustrates an updated heat map 462′ which utilizes sonar return data collected between 8:00 am and 12:00 pm. In this regard, any sonar return data that was collected outside of 8:00 am and 12:00 pm is removed from the population density calculation. Thus, the updated heat map 462′ illustrates the filtered population density within that time frame, which may be averaged over the number of datasets used. As illustrated, each of the first area 438 and the second area 439 illustrate different population densities than depicted on the initial heat map 462 of FIG. 6A. In this regard, the population density within the first area 438 decreased, while the population density within the second area 439 increased.

To explain further, fish may have the desire to be in different areas of the water during different times of the day due to different water temperatures. In the illustrated embodiment, the first area 438 and the second area 439 include a third indication 435c indicating a third population density and a fourth indication 435d indicating a fourth population density. In some embodiments, the third indication 435c may indicated a population density between the first population density and the second population density, and the fourth population density may be between the second population density and the third population density. In this regard, in the illustrated embodiment, as the first area 438 is in a deeper area of the body of water 101 in the early hours, there may be a lower population density of fish within the area. In comparison, as the second area 439 is in a shallower area of the body of water 101, the second area 439 may have a higher population density in the earlier hours. Thus, when the heat map depicts the population density within a period of time, the user may have a better indication of desirable fishing areas.

Similarly, the season, or time of year may have an impact on the fish density in a given area as fish may be migratory, and/or may go to different areas of the body of water based on breeding habits. Thus, the user may be able to combine one or more time period filters to include a date range, and a time range as desired. In some embodiments, the user may also be able to use the time period filter to only use data collected after a certain day.

When a user is new to fishing, or travels to a new body of water, the user may not have adequate data, or any data to use to create a heat map of the population density within the body of water. In order to improve the fishing experience, the user may optionally be able to utilize sonar data from other sources to create a heat map of the population density within the body of water.

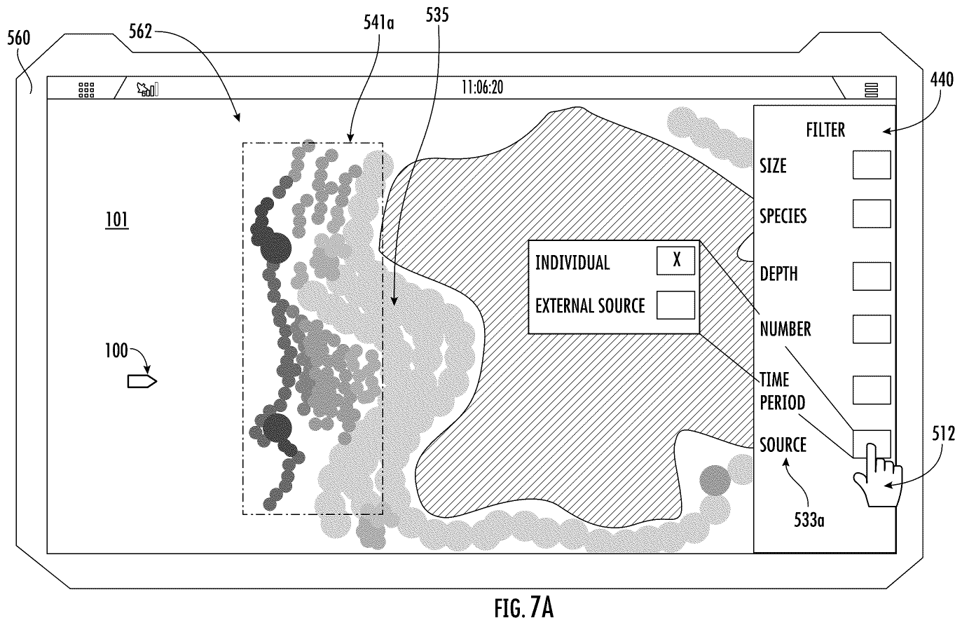

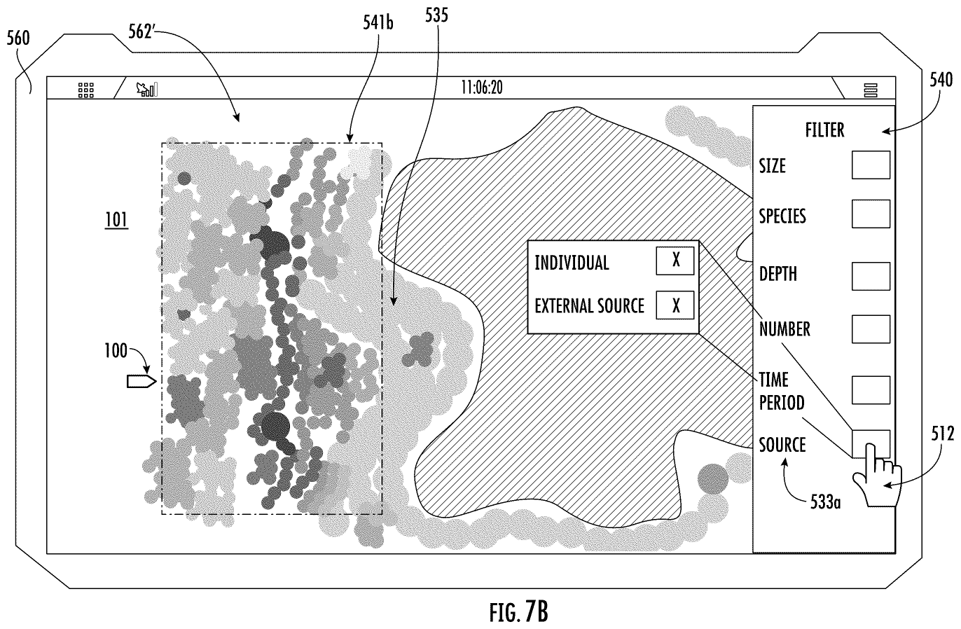

FIGS. 7A-B illustrate using different data sources to filter population densities. FIG. 7A illustrates an initial heat map 562 generated from an individual data source presented on a marine electronics device 560. The initial heat map 562 is overlaid on a navigational map (e.g., 161 FIG. 2) which includes indications 535 which correspond to the population density within that area. Using only individually collected data the heat map 562 covers a first area 541a which covers a portion of the body of water 101. In order to generate a more accurate heat map, a user 512 may select other sources (such as external source, shown at 533a) as a manipulated variable and include external sourced data in addition to individual data.

FIG. 7B illustrates an updated heat map 562′ wherein the source 533a is both individual data, and external sourced data. In this regard, the updated heat map 562′ depicts the population across a coverage area 541b which is larger than the individual coverage area 541a. In some embodiments, the external sourced data may contain the same types of data as the individual data, for example, the time stamp which includes the date and time of the data collection, the fish count, the fish depth, the fish size, the estimated fish species, and/or the water temperature, among other factors.

Although each of these variables are illustrated individually, it should be understood, that each of these variables may be compounded as the user desires. In this regard, the user may filter the heat map results by both time and depth, time and fish species, fish size fish species and source, etc.

### Example System Architecture

FIG. 8 illustrates a block diagram of an example system 700 according to various embodiments of the present invention described herein. The illustrated system 700 includes a marine electronic device 760. In some embodiments, the system 700 may comprise numerous marine devices. As shown in FIG. 8, one or more sonar transducer assemblies 702a, 702b and one or more radar 709 may be provided. One or more marine devices may be implemented via the marine electronic device 760. For example, a position sensor 745, a direction sensor 748, an autopilot 750, and other sensors 752 may be provided within the marine electronic device 760. These marine devices may be integrated within the marine electronic device 760, integrated on a watercraft at another location and connected to the marine electronic device 760, and/or the marine devices may be implemented at a remote device 754 in some embodiments. The system 700 may include any number of different systems, modules, or components; each of which may comprise any device or means embodied in either hardware, software, or a combination of hardware and software configured to perform one or more corresponding functions described herein.

The marine electronic device 760 may include at least one processor 710, a memory 720, a communication interface 730, a user interface 735, a display 740, a sonar signal processor 788, and one or more sensors (e.g., position sensor 745, direction sensor 748, other sensors 752). One or more of the components of the marine electronic device 760 may be located within a housing or could be separated into multiple different housings (e.g., be remotely located).

The processor(s) 710 may be any means configured to execute various programmed operations or instructions stored in a memory device (e.g., memory 720) such as a device or circuitry operating in accordance with software or otherwise embodied in hardware or a combination of hardware and software (e.g. a processor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions of the at least one processor 710 as described herein. For example, the at least one processor 710 may be configured to analyze sonar data, radar data, and chart data to correlate a chart scale and a sonar scale described herein (e.g., generate a navigational chart, determine a chart scale, generate a sonar image, determine a sonar image scale, adjust the chart scale to a second zoom level such that the chart scale is equivalent to the sonar image scale, etc.).

In some embodiments, the at least one processor 710 may be further configured to implement signal processing. In some embodiments, the at least one processor 710 may be configured to perform enhancement features to improve the display characteristics of data or images, collect or process additional data, such as time, temperature, GPS information, waypoint designations, current, environmental conditions (e.g., wind speed, wind direction) or others, or may filter extraneous data to better analyze the collected data.

In an example embodiment, the memory 720 may include one or more non-transitory storage or memory devices such as, for example, volatile and/or non-volatile memory that may be either fixed or removable. The memory 720 may be configured to store instructions, computer program code, sonar data, radar data, chart data, and additional data such as, bathymetric data, location/position data in a non-transitory computer readable medium for use, such as by the at least one processor 710 for enabling the marine electronic device 760 to carry out various functions in accordance with example embodiments of the present invention. For example, the memory 720 could be configured to buffer input data for processing by the at least one processor 710. Additionally or alternatively, the memory 720 could be configured to store instructions for execution by the at least one processor 710.

The communication interface 730 may be configured to enable communication to external systems (e.g., an external network 790). In this manner, the marine electronic device 760 may retrieve stored data from a remote device 754 via the external network 790 in addition to or as an alternative to the onboard memory 720. Additionally or alternately, the marine electronics device 760 may store marine data locally, for example within the memory 720. Additionally or alternatively, the marine electronic device 760 may transmit or receive data, such as environmental conditions. In some embodiments, the marine electronic device 760 may also be configured to communicate with other devices or systems (such as through the external network 790 or through other communication networks, such as described herein). For example, the marine electronic device 760 may communicate with a propulsion system of the watercraft 100 (e.g., for autopilot control); a remote device (e.g., a user's mobile device, a handheld remote, etc.); or another system. Using the external network 790, the marine electronic device 760 may communicate with and send and receive data with external sources such as a cloud, server, etc. The marine electronic device 760 may send and receive various types of data. For example, the system may receive weather data, tidal data, alert data, current data, among others. However, this data is not required to be communicated using external network 790, and the data may instead be communicated using other approaches, such as through a physical or wireless connection via the communications interface 730.

The communications interface 730 of the marine electronic device 760 may also include one or more communications modules configured to communicate with one another in any of a number of different manners including, for example, via a network. In this regard, the communications interface 730 may include any of a number of different communication backbones or frameworks including, for example, Ethernet, the NMEA 2000 framework, GPS, cellular, Wi-Fi, or other suitable networks. The network may also support other data sources, including GPS, autopilot, engine data, compass, radar, etc. In this regard, numerous other peripheral devices (including other marine electronic devices or sonar transducer assemblies) may be included in the system 700.

The position sensor 745 may be configured to determine the current position and/or location associated with travel of the marine electronic device 760 (and/or the watercraft 100). For example, the position sensor 745 may comprise a GPS, bottom contour, inertial navigation system, such as machined electromagnetic sensor (MEMS), a ring laser gyroscope, or other location detection system. Additionally or alternately, the position sensor 745 may be configured to determine the orientation of the watercraft 100. Alternatively or in addition to determining the location of the marine electronic device 760 or the watercraft 100, the position sensor 745 may also be configured to determine the position and/or orientation of an object outside of the watercraft 100. In some embodiments, the position sensor 745 may be configured to determine a location associated with travel of the watercraft. For example, the position sensor 745 may utilize other sensors 752 (e.g., speed sensor, and/or direction sensor 748) to determine a future position of the watercraft 100 and/or a waypoint along the route of travel.

The display 740 (e.g., one or more screens) may be configured to present images and may include or otherwise be in communication with a user interface 735 configured to receive input from a user. The display 740 may be, for example, a conventional LCD (liquid crystal display), a touch screen display, mobile device, or any other suitable display known in the art upon which images may be displayed.

In some embodiments, the display 740 may present one or more sets of data (or images generated from the one or more sets of data). Such data includes chart data, radar data, sonar data, weather data, location data, position data, orientation data, environmental data, sonar data, or any other type of information relevant to the watercraft. Environmental data may be received from the external network 790, retrieved from the other sensors 752, and/or obtained from sensors positioned at other locations, such as remote from the watercraft. Additional data may be received from marine devices such as a radar, a primary motor 705 or an associated sensor, a trolling motor 708 or an associated sensor, an autopilot 750, a rudder 757 or an associated sensor, a position sensor 745, a direction sensor 748, additional sensors 719, a remote device 754, onboard memory 720 (e.g., stored chart data, historical data, stored sonar data, etc.), or other devices.

In some further embodiments, various sets of data, referred to above, may be superimposed or overlaid onto one another. In some embodiments, the processor 710 may be configured to correlate the data sets to present on the display 740 such that each of the data sets present information for the same area. For example, the processor 710 and/or the sonar signal processor 788 may receive a first sonar data set from the one or more sonar transducer assemblies 702a, 702b. The processor 710 may retrieve a chart data set from the memory 720. The processor 710 may generate a navigational chart from the chart data and display the navigational chart at a last used zoom level with a chart scale. Upon receipt of the sonar data, the processor 710 and/or sonar signal processor 788 may detect one or more objects within the sonar data, and may tag the one or more objects with corresponding sonar data, for example depth, number of objects, location of the detected object, estimated species of the object, time of detection, etc. The processor 710 may utilize the indication of the one or more detected objects and calculate a population density. The processor 710, may further generate a heat map corresponding to the population density and overlay the heat map over the navigational chart.

The user interface 735 may include, for example, a keyboard, keypad, function keys, mouse, scrolling device, input/output ports, touch screen, or any other mechanism by which a user may interface with the system.

Although the display 740 of FIG. 8 is shown as being directly connected to the at least one processor 710 and within the marine electronic device 760, the display 740 could alternatively be remote from the at least one processor 710 and/or marine electronic device 760. Likewise, in some embodiments, the position sensor 745 and/or user interface 735 could be remote from the marine electronic device 760.

The marine electronic device 760 may include one or more other sensors/devices 752, such as configured to measure or sense various other conditions. The other sensors/devices 752 may include, for example, an air temperature sensor, a water temperature sensor, a current sensor, a light sensor, a wind sensor, a speed sensor, tide sensor, or the like.

The sonar transducer assemblies 702a, 702b illustrated in FIG. 8 may include one or more sonar transducer elements 767a, 767b, such as may be arranged to operate alone or in one or more transducer arrays. In some embodiments, additional separate sonar transducer elements (arranged to operate alone, in an array, or otherwise) may be included. As indicated herein, the sonar transducer assemblies 702a, 702b may also include a sonar signal processor 788 or other processor (although not shown) configured to perform various sonar processing. In some embodiments, the processor (e.g., at least one processor 710 in the marine electronic device 760, a controller (or processor portion) in the sonar transducer assemblies 702a, 702b, or a remote controller—or combinations thereof) may be configured to filter sonar return data and/or selectively control transducer element(s) 767a, 767b. For example, various processing devices (e.g., a multiplexer, a spectrum analyzer, A-to-D converter, etc.) may be utilized in controlling or filtering sonar return data and/or transmission of sonar signals from the transducer element(s) 767a, 767b.

The sonar transducer assemblies 702a, 702b may also include one or more other systems, such as various sensor(s) 766a, 766b. For example, the sonar transducer assembly 702a, 702b may include an orientation sensor, such as gyroscope or other orientation sensor (e.g., accelerometer, MEMS, etc.) that can be configured to determine the relative orientation of the sonar transducer assembly 702a, 702b and/or the one or more sonar transducer element(s) 767a, 767b—such as with respect to a forward direction of the watercraft. In some embodiments, additionally or alternatively, other types of sensor(s) are contemplated, such as, for example, a water temperature sensor, a current sensor, a light sensor, a wind sensor, a speed sensor, or the like.

The components presented in FIG. 8 may be rearranged to alter the connections between components. For example, in some embodiments, a marine device outside of the marine electronic device 760, such as the radar, may be directly connected to the at least one processor 710 rather than being connected to the communication interface 730. Additionally, sensors and devices implemented within the marine electronic device 760 may be directly connected to the communications interface 730 in some embodiments rather than being directly connected to the at least one processor 710.

### Example Flowchart(s) and Operations

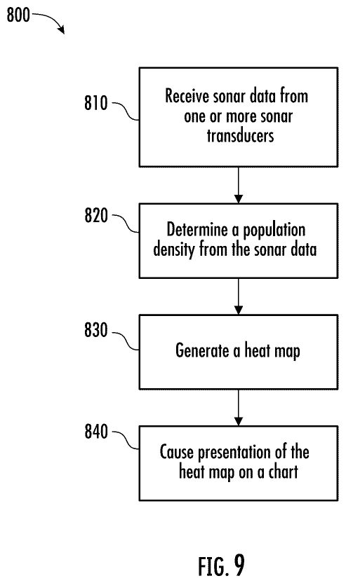

Some embodiments of the present invention provide methods, apparatus, and computer program products related to the presentation of information according to various embodiments described herein. Various examples of the operations performed in accordance with embodiments of the present invention will now be provided. FIG. 9 illustrates a flow chart with an example method for presenting marine data according to various embodiments described herein. The method may be performed by a wide variety of components, including, but not limited to, one or more processors, one or more microprocessors, and one or more controllers. In some embodiments, a marine electronic device 760 (FIG. 8) may comprise one or more processors that perform the functions shown in FIG. 9. Further, various operations of the method may be provided on a piece of software which runs on a central server that is at a remote location away from the watercraft, and the remote server may communicate with a processor or a similar component on the watercraft. Additionally, the methods could be integrated into a software update that may be installed onto existing hardware, or the methods may be integrated into the initial software or hardware provided in a radar unit, watercraft, server, etc.

FIG. 9 is a flowchart of an example method 800 for generating a heat map overlay indicating a population density of a biomass over a navigational chart, in accordance with some embodiments discussed herein. The operations illustrated in and described with respect to FIG. 9 may, for example, be performed by, with the assistance of, and/or under the control of one or more of the processor 710, memory 720, communication interface 730, user interface 735, position sensor 745, direction sensor 748, other sensor 752, sonar signal processor 788, transducer assembly 702a, 702b, display 740, and/or external network 790/remote device 754.

At operation 702, the method 700 may comprise receiving sonar data from one or more sonar transducers. In some embodiments, receiving sonar data may comprise emitting one or more sonar beams into an underwater environment in a direction relative to the watercraft, and receiving sonar returns corresponding to the one or more emitted sonar beams. The received sonar data may include an indication of at least a number of detected fish, or other objects, and a corresponding location. In some embodiments, the received sonar data may further be associated with (or otherwise indicate) a time period, an object depth, current environmental conditions, an object size, or similar data.

At operation 820, the method 800 further comprises determining a population density from the sonar data. In some embodiments, determining a population density may comprise analyzing the sonar return data to determine the number of fish or other objects detected within the sonar returns at a given location. At operation 830, the method 800 may comprise generating a heat map. The heat map may provide a visual indication of the one or more population densities at a corresponding location on a navigational chart. At operation 840, the method 800 may further comprise causing, on the display, presentation of the heat map on a chart. In this regard, the heat map may be overlaid onto the navigational chart to provide the user a visual indication of the varying population densities within the body of water, and may aid the user in a determination of a fishing location.

FIG. 9 illustrates a flowchart of a system, method, and computer program product according to various example embodiments. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory 720 and executed by, for example, the processor 710. As will be appreciated, any such computer program product may be loaded onto a computer or other programmable apparatus (for example, a marine electronic device 760) to produce a machine, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device (for example, a marine electronic device 760) to cause a series of operations to be performed on the computer or other programmable apparatus to produce a computer-implemented process such that the instructions which execute on the computer or other programmable apparatus implement the functions specified in the flowchart block(s).

### Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A system for providing marine data, the system comprising:
a display;
a processor; and
a memory including computer program code, the computer program code, configured to, when executed, cause the processor to:
cause, on the display, presentation of a chart indicating at least a portion of a body of water;
receive sonar data from one or more sonar transducers associated with a watercraft, wherein the one or more sonar transducers are configured to emit one or more sonar beams into an underwater environment in a direction relative to the watercraft and to receive sonar returns corresponding to the one or more emitted sonar beams, wherein the sonar data is associated with a corresponding location;
determine, based on the sonar data, a population density of fish at a location;
generate a heat map based on the population density, wherein the heat map indicates one or more population densities at corresponding locations on the chart; and
cause, on the display, presentation of the heat map over the chart.

2. The system of claim 1, wherein the heat map is generated based on at least one variable for the sonar data, wherein the at least one variable is a time period, a fish size, a fish depth range, a current environmental condition, or a fish species.

3. The system of claim 2, wherein the computer program code, the computer program code is further configured to, when executed, cause the processor to:
receive an input indicating the at least one variable;
determine a filtered population density based on the indicated variable;
generate an updated heat map based on the filtered population density; and
cause, on the display, presentation of the updated heat map.

4. The system of claim 2, wherein the time period is one of a time of day, a time of year, or a specific time interval.

5. The system of claim 2, wherein the computer program code is further configured to, when executed, cause the processor to:
determine, automatically, a current time;
determine the population density based at least partially on the current time.

6. The system of claim 5, wherein the computer program code is further configured to, when executed, cause the processor to:
determine, automatically, an updated time;
determine the population density based at least partially on the updated time.

7. The system of claim 2, wherein the computer program code is further configured to, when executed, cause the processor to:
determine a desired fish species; and
determine the population density based at least partially on the determined fish species.

8. The system of claim 1, wherein the computer program code is further configured to, when executed, cause the processor to:
determine the population density based on external sourced sonar data corresponding to the location.

9. The system of claim 8, wherein the external sourced sonar data identifies at least one variable, wherein the at least one variable is a time period, a fish size, a fish depth range, a current environmental condition, or a fish species.

10. The system of claim 1, wherein the heat map comprises at least a first pattern corresponding to a first population density and a second pattern corresponding to a second population density, wherein the first population density is different than the second population density.

11. A method for displaying marine information, the method comprising:
receiving sonar data from one or more sonar transducers associated with a watercraft, wherein the one or more sonar transducers are configured to emit one or more sonar beams into an underwater environment in a direction relative to the watercraft and to receive sonar returns corresponding to the one or more emitted sonar beams, wherein the sonar data is associated with a corresponding location;
determining a population density of fish at a location based on the sonar data;
generating a heat map based on the population density, wherein the heat map indicates one or more population densities at corresponding locations on the chart; and
causing, on the display, presentation of the heat map over the chart.

12. The method of claim 11, wherein the heat map is generated based on at least one variable, wherein the at least one variable is a time period, a fish size, a fish depth range, a current environmental condition, or a fish species.

13. The method of claim 12, further comprising:
receiving an input indicating the at least one variable; and
determining the population density based on the indicated variable.

14. The method of claim 13, wherein the time period is one of a time of day, a time of year, or a specific time interval.

15. The method of claim 11, further comprising:
determining, automatically, a current time;
determining the population density based at least partially on the current time.

16. The method of claim 12, further comprising:
determining a desired fish species;
determining the population density based at least partially on the determined fish species.

17. The method of claim 11, further comprising:
determining the population density based at least partially on external sourced sonar data.

18. The method of claim 11, wherein the heat map comprises at least a first pattern corresponding to a first population density and a second pattern corresponding to a second population density, wherein the first population density is different than the second population density.

19. A marine electronics device comprising:
a user interface comprising a display;
a processor;
a memory including computer program code, the computer program code, configured to, when executed, cause the processor to:
cause, on the display, presentation of a chart indicating at least a portion of a body of water;
receive sonar data from one or more sonar transducers associated with a watercraft, wherein the one or more sonar transducers are configured to emit one or more sonar beams into an underwater environment in a direction relative to the watercraft and to receive sonar returns corresponding to the one or more emitted sonar beams, wherein the sonar data is associated with a corresponding location;
receive, at the user interface, an indication of a selected variable, wherein the selected variable is one of a time period, a fish size, a fish depth range, a current environmental condition, or a fish species;
determine a population density of fish at a location based on the sonar data and the selected variable;
generate a heat map based on the population density, wherein the heat map indicates one or more population densities at corresponding locations on the chart; and
cause, on the display, presentation of the heat map over the chart.

20. The marine electronics device of claim 19, wherein the computer program code is further configured to, when executed, cause the processor to:
determine the population density based at least partially on external sourced sonar data.
